(19) United States
(12) Patent Application Publication
(10) Pub. No.: US 2009/0050453 A1
(43) Pub. Date: Feb. 26, 2009

(54) Explosion proof safety switch apparatus

(75) Inventors: Gary Eisenhower, JR., Freeport, IL (US); Jeffrey S. Hall, Winnebago, IL (US); Mark Mantua, Freeport, IL (US)

Correspondence Address: Bryan Anderson Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/895,058

(22) Filed: Aug. 23, 2007

(51) Int. Cl. H01H 9/04

(52) U.S. Cl. 200/302.1

(57) ABSTRACT

A safety switch apparatus includes one or more switching elements in association with an operating head. A housing and a cover are provided for maintaining the switching element(s) therein. A switch cavity is formed between the housing and the cover to maintain the switching element(s) in the switch cavity between the housing and the cover. A plurality of cover-housing threads are provided by the housing and the cover in association with a plunger extending between the switch cavity and the operating head, thereby providing a weather-sealed and explosion-proof barrier for protecting the switching element(s).

### TECHNICAL FIELD

Embodiments are generally related to safety switching devices for connecting and safely disconnecting an electrical load. Embodiments are also related to explosion-proof and EM resistant devices.

### BACKGROUND OF THE INVENTION

Safety switching devices are primarily used in the industrial sector, in order to connect and, especially, in order to safely disconnect electrically driven machines, such as control valves, actuators, a brake press, a milling tool and so forth. Such devices are particularly used in conjunction with mechanically operated emergency-off buttons to disconnect the machine quickly and reliably in an emergency situation. For this purpose, the power supply for the machine which is to be disconnected is generally passed via make contacts of two relays or contactors acting as switching elements. The switching elements are driven by the safety switching device in a fail-safe manner. As soon as any one of the two switching elements opens its make contacts, the power supply to the machine is interrupted.

Industrial limit switches, such as global limit switches, safety interlocks, safety solenoid interlocks and cable pull limit switches are used in a variety of industrial applications. Limit switches contain switches that are manufactured to suit the particular application.

Typically, switches used in these products are designed and manufactured for a particular contact arrangement. Such switches generally contain two or more circuits having one or more normally closed (NC) contacts and/or one or more normally open (NO) contacts. Conventional arrangements typically include one normally open/one normally closed, also called a “single pole” arrangement, or two normally open/two normally closed, also called a “double pole” arrangement. Conventional industrial limit switches often require additional normally closed contacts for added redundancy. Limit switch applications often require at least three positively driven, normally closed contacts along with one normally open monitor circuit.

One of the problems with such prior art safety switching devices is the lack of explosion-proof features. While standards apply to switch types that can be used for explosion risk areas and standards apply for safety switches, in many cases this is ignored with the explosion proof requirement taking precedence over positive break. Currently, there does not exist a weather-sealed, explosion-proof, positive opening safety limit switch with multiple head styles and switch configurations for use either indoor or outdoors in hazardous atmospheres. It is believed that the improved safety switch apparatus disclosed in greater detail herein offers these features.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved safety-switch apparatus

It is another aspect of the present invention to provide for a weather-sealed and explosion-proof safety switch apparatus.

It is a further aspect of the present invention to provide for a safety switch apparatus that can utilize multiple operating head styles and switch configurations.

The aforementioned aspects of the invention and other objectives and advantages can now be achieved as described herein. A safety switch apparatus is disclosed, wherein includes one or more switching elements in association with an operating head. A housing and a cover are provided for maintaining the switching element(s) therein. A switch cavity is formed between the housing and the cover to maintain the switching element(s) in the switch cavity between the housing and the cover. A plurality of cover-housing threads are provided by the housing and the cover in association with a plunger extending between the switch cavity and the operating head, thereby providing a weather-sealed and explosion-proof barrier for protecting the switching element(s).

The operating head is field adjustable at 90 degree increments, and can be equipped with one or more side rotary actuators adjustable for a clockwise operation and a counter-clockwise operation. An O-Ring seal is also located between the housing and the cover. Additionally, a flame path is provided by the cover-housing threads and the plunger extending between the switch cavity and the operating head. The cover is generally circularly-shaped and is removable to expose the switching element(s) for wiring and replacement thereof. One or more wrenching lugs also extend from a front of the cover to permit the removal or tightening of the cover. External and/or internal grounding mechanisms can also provide an earth ground for the housing. The switching element(s) generally constitute a positive-opening switch in association with a fixed side rotary lever, a top-pin plunger and a top roller plunger and top roller lever.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a left perspective view of a weather-sealed, explosion proof, positive-opening safety switch apparatus, in accordance with a preferred embodiment;

FIG. 2 illustrates a right perspective view of the safety switch apparatus depicted in FIG. 1, in accordance with a preferred embodiment; and

FIG. 3 illustrates a front view of the safety switch apparatus depicted in FIGS. 1-2;

FIGS. 4-5 illustrate respective front and side views of a safety switch apparatus having a side rotary head and lever configuration in accordance with an alternative embodiment;

FIGS. 6-7 illustrate respective front and side views of a safety switch apparatus having an alternative rotary head and lever configuration and an extending rod, in accordance with an alternative embodiment;

FIGS. 8-9 illustrate respective front and side views of a safety switch apparatus having a side rotary head configuration alternative levers, in accordance with an alternative embodiment;

FIGS. 10-11 illustrate respective front and side views of a safety switch apparatus with a top pin plunger configuration, in accordance with an alternative embodiment;

FIGS. 12-13 illustrate respective front and side views of a safety switch apparatus with a top roller plunger head configuration, in accordance with an alternative embodiment;

FIGS. 14-15 illustrate respective front and side views of a safety switch apparatus having a top lever head, in accordance with an alternative embodiment;

FIGS. 16-17 illustrate respective front and side views of a safety switch apparatus having a wobble head and cat whisker head coil actuator in accordance with an alternative embodiment;

FIGS. 18-22 illustrate various types of actuators, which can be adapted for use in accordance with preferred or alternative embodiments; and

FIGS. 23-25 illustrate angular actuation for a safety switch apparatus, which can be implemented in accordance with an alternative embodiment.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

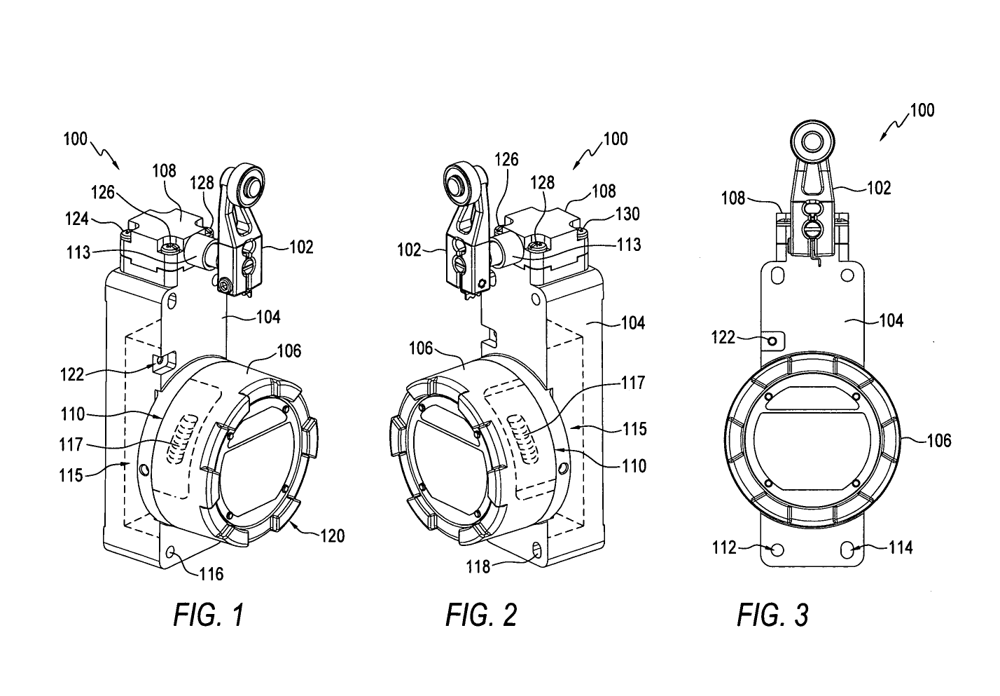

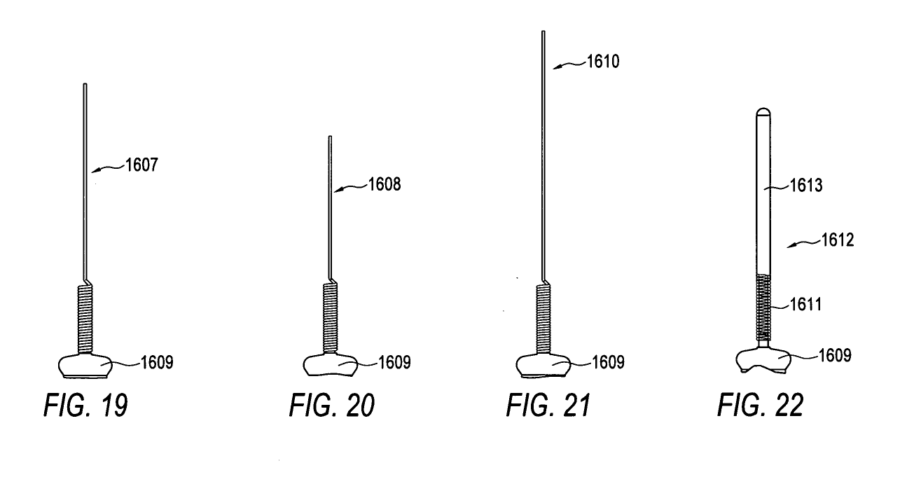

FIG. 1 illustrates a left perspective view of a weather-sealed, explosion proof, positive-opening safety switch apparatus 100, in accordance with a preferred embodiment. FIG. 2 illustrates a right perspective view of the safety switch apparatus 100 depicted in FIG. 1, in accordance with a preferred embodiment. FIG. 3 illustrates a front view of the safety switch apparatus 100 depicted in FIGS. 1-2. Note that in FIGS. 1-25, identical or similar parts or elements are generally indicated by identical reference numerals.

A housing 104 and a cover 120 are provided for maintaining one or more switching element(s) 117 therein. An operating head 108 is connected to the housing 104 via screws 124, 126, 128 and 130. A lever 102 is generally attached to the operation head 108. Note that although screws 124, 126, 128 and 130 can be utilized to attach the operating head 108 to the housing 104, it can be appreciated that other types of non-screw attachment mechanisms may be utilized in place of or in addition to the screws 124, 126, 128 and 130, depending upon design considerations. The housing 104 and the cover 120 can be formed from a material such as, but not limited to, cast aluminum.

A switch cavity 115 is formed between the housing 104 and the cover 120 to maintain the switching element(s) 117 in the switch cavity 115 between the housing 104 and the cover 120. A plurality of cover-housing threads (not shown) are provided by the housing 104 and the cover 120 in association with a plunger 113 extending between the switch cavity 115 and the operating head 108, thereby providing a weather-sealed and explosion-proof barrier for protecting the switching element(s) 117 therein.

The operating head 108 is field adjustable at 90 degree increments, and can be equipped with one or more side rotary actuators (not shown) adjustable for a clockwise operation and a counter-clockwise operation. An O-Ring seal 110 can be located between the housing 104 and the cover 120. Additionally, a flame path (not shown) can be provided by the cover-housing threads and the plunger 113 extending between the switch cavity 115 and the operating head 108. The cover 120 is generally circularly-shaped and is removable to expose the switching element(s) 117 for wiring and replacement thereof.

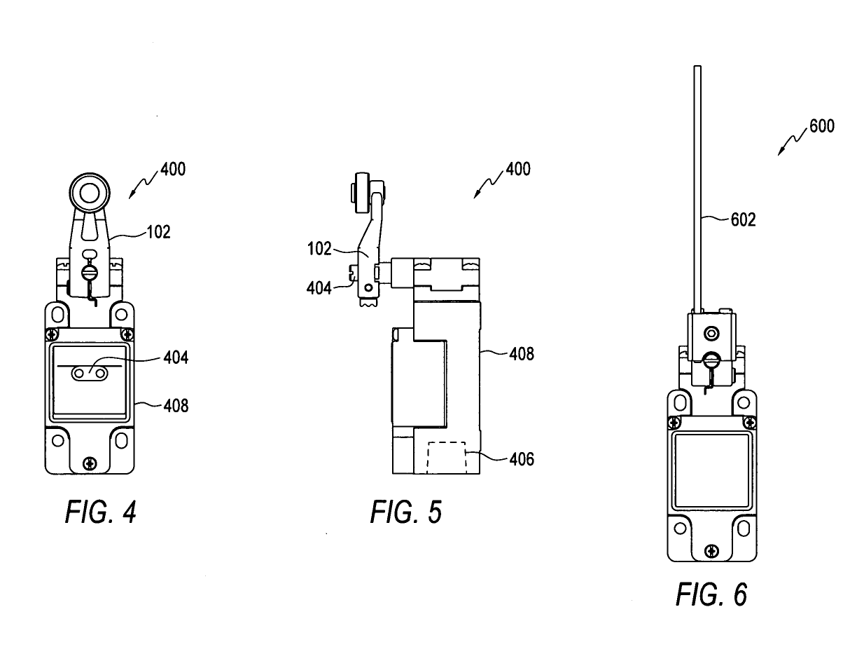

One or more wrenching lugs also extend from a front of the cover 120 to permit the removal or tightening of the cover. External and/or internal grounding mechanism(s) 122 can also provide an earth ground for the housing 104. Such grounding mechanism(s) 122 can be implemented as both internal and external grounding screws, depending upon design considerations. Additionally, areas 112 and 114 can be provided in the form of DIN style spacing horizontally for hole placement thereof. The switching element(s) 117 generally constitute a positive-opening switch in association with a fixed side rotary lever, a top-pin plunger, a top roller plunger, and top roller lever, which are shown in greater detail in FIGS. 4-25 herein.

The safety switch apparatus 100 therefore offers a weather-sealed explosion-proof, positive opening safety limit switch with multiple head styles and switch configurations for use either indoor or outdoor and in hazardous atmospheres. The safety switch apparatus 100 features a foot print with multiple head 108 styles to choose from. The head styles used in conjunction with the positive-opening basic switch can be associated with a fixed side rotary lever, a top pin plunger, a top roller plunger and a top roller lever. Various head styles and arrangements are illustrated in further detail herein with respect to FIGS. 4-24. Note that preferably, all operating heads are field adjustable at 90 degree increments. Operating heads with side rotary actuators can be adjusted for clockwise and counter clockwise operation. The positive-opening basics offered in such a safety switch apparatus 100 include, but are not limited to (SPDT) Single Pole, Double Throw contacts (1NC/1NO), (DPDT) Double Pole, Double Throw contacts (2NC/2NO) and 4-circuit contact blocks, depending upon design considerations and the particular switching application.

Due to the configuration of the safety switch apparatus 100, the apparatus 100 can withstand the pressure of an internal explosion and cools the exploding gases below the kindling temperature of the explosive atmosphere. Flame paths are provided by the cover-housing threads and an extended plunger between the switch cavity 115 and the operating head 108. The housing 104 and the cover 120 can be both configured from a non-sparking cast aluminum. The O-ring seal 110 is located between the housing 104 and cover 120. The circular cover 129 on the front of apparatus 100 is easily unscrewed to expose the switching elements for wiring and replacement. A tool or bar used on the wrenching lugs extending from the front of the cover 120 allows easy removal or tightening.

The safety switch apparatus 100 is ideal for outdoor use or in adverse environments where a combination of explosion-proof plus sealing requirements is needed. To comply with explosion-proof requirements, the safety switch apparatus 100 possesses flame paths within the housing 120, which cool expanding gases surrounding the housing 120. Flame baths on the safety switch apparatus 100 can be provided by (1) the extended plunger 113 between the switch cavity 115 and the operation head 108; and (2) the covering-housing threads on the front of the switching element(s) 117. Typical applications for safety switch apparatus 100 include, for example, but not limited to, control valves and actuators, offshore drilling, grain elevators, petrochemical plants, chemical plants, waste treatment, paint booths, mining conveyors, pulp and paper coating, hazardous waste handling and so forth.

What separates safety switch apparatus 100 from standard switches is the incorporation positive operation features. All safety switches (key operated interlocks, safety switches, safety rope pull products) feature positive break contacts on normally closed circuits(s). These circuits can be identified by the positive break symbol which is a circle with a left to right bold arrow in the centre of the circle. Positive break ensures that should the NC circuit be subjected to a fault current or voltage which causes the contacts to weld closed, then by applying pressure to the plunger or pulling on the key or rotating the lever or pulling on the rope, the switch mechanism is designed to force apart the contacts, therefore breaking the weld. This ensures that an open circuit occurs even under an electrical fault condition. It can be usual practice to protect the safety circuit with a fuse of an appropriate rating for the control current being used however, if this additional security is shorted out or bypassed, positive break ensures that the contacts will separate when required.

FIGS. 4-5 illustrate respective front and side views of a safety switch apparatus 400 having a side rotary head and lever configuration in accordance with an alternative embodiment. Note that the safety switch apparatus 400 depicted in FIGS. 4-5 and the other safety switch embodiments described herein with respect to FIGS. 6-25 herein represent variations to the safety switch apparatus 100 depicted in FIGS. 1-3. In the configuration depicted in FIGS. 4-5, lever 102 is shown, which is similar to the lever 102 depicted in FIGS. 1-3. The safety switch apparatus 400 generally includes an indicator 404, which can include left and right indicator lights indicative of an output status. The safety switch apparatus 400 additionally includes a conduit entry 406 disposed within a body 408.

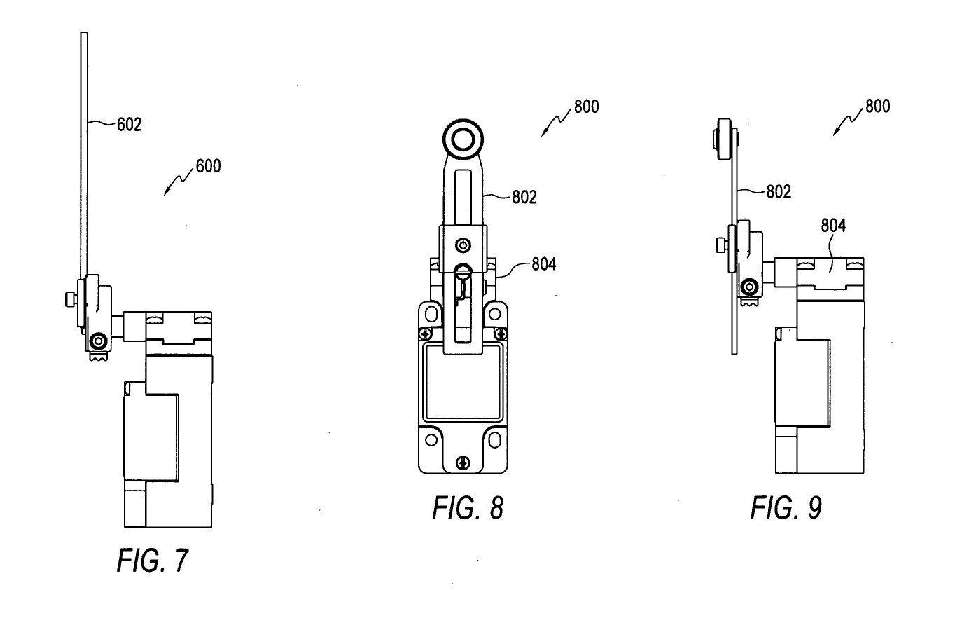

FIGS. 6-7 illustrate respective front and side views of a safety switch apparatus 600 having an alternative rotary head and lever configuration and an extending rod, in accordance with an alternative embodiment. Safety switch apparatus 600 is similar to the safety switch apparatus 100, 400 described earlier, but includes the use of a rod 602, which may be formed from an aluminum material or a stainless steel material, depending upon design considerations. The configuration depicted in FIGS. 6-7 thus represents an alternative lever arrangement.

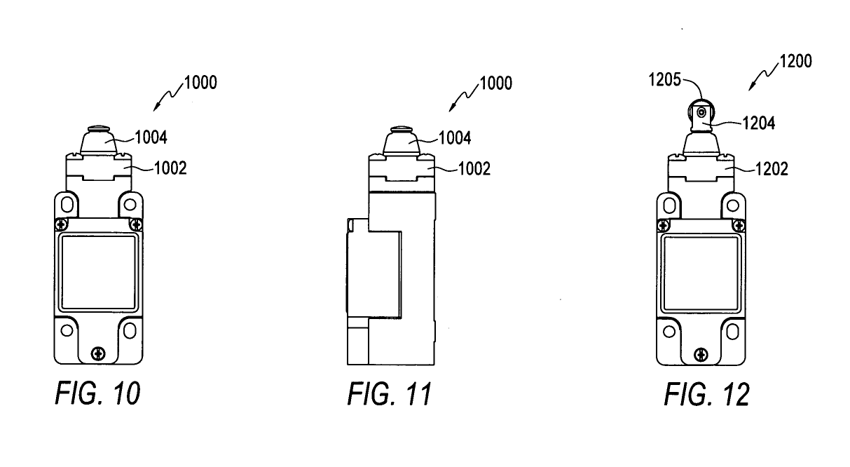

FIGS. 8-9 illustrate respective front and side views of a safety switch apparatus 800 having a side rotary head configuration alternative levers, in accordance with an alternative embodiment. The safety switch apparatus 800 includes side rotary head 804 and lever 802. FIGS. 10-11 illustrate respective front and side views of a safety switch apparatus 1000 with a top pin plunger configuration, in accordance with an alternative embodiment. In the configuration depicted in FIGS. 8-9, a top pin plunger head 1002 with a plunger 1004 thereon. The safety switch apparatus 1000 is similar to the safety switch devices 100, 400, etc., that were described earlier herein, but includes the alternative top pin plunger 1004 and head 1002 configuration illustrated in FIG. 8-9.

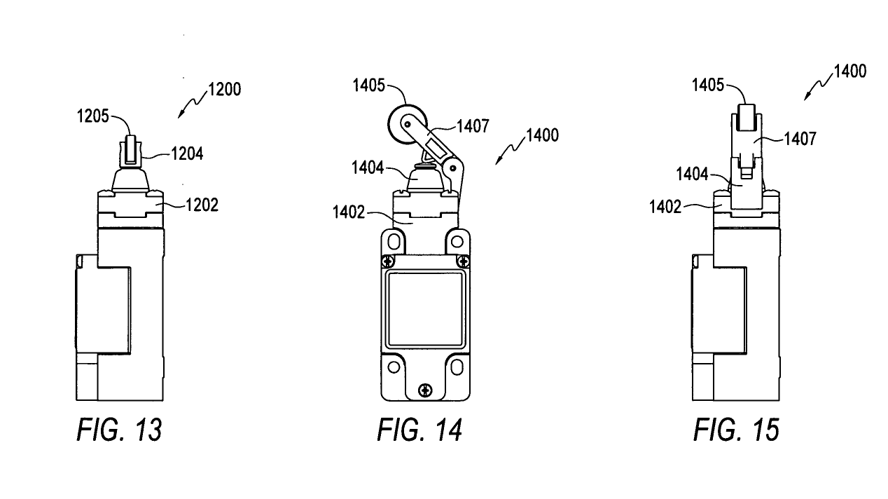

FIGS. 12-13 illustrate respective front and side views of a safety switch apparatus 1200 with a top roller plunger head configuration, in accordance with an alternative embodiment. The safety switch apparatus 1200 is similar to the safety switch devices 100, 400, etc., that were described earlier herein, but includes a roller 1205 disposed in a rolling portion 1204 for maintaining the roller 1205 and a plunger head 1205 which is attached to and/or integrated with the rolling portion 1204 and roller 1205. The roller 1205 may be composed of a material, such as steel, depending upon design considerations.

FIGS. 14-15 illustrate respective front and side views of a safety switch apparatus 1400 having a top lever head, in accordance with an alternative embodiment. The safety switch apparatus 1400 is similar to the safety switch devices 100, 400, etc., that were described earlier herein, but includes a roller 1405 maintaining by a rolling portion 1407 for maintaining roller 1405. A top head 1402 is also included along with a plunger 1404.

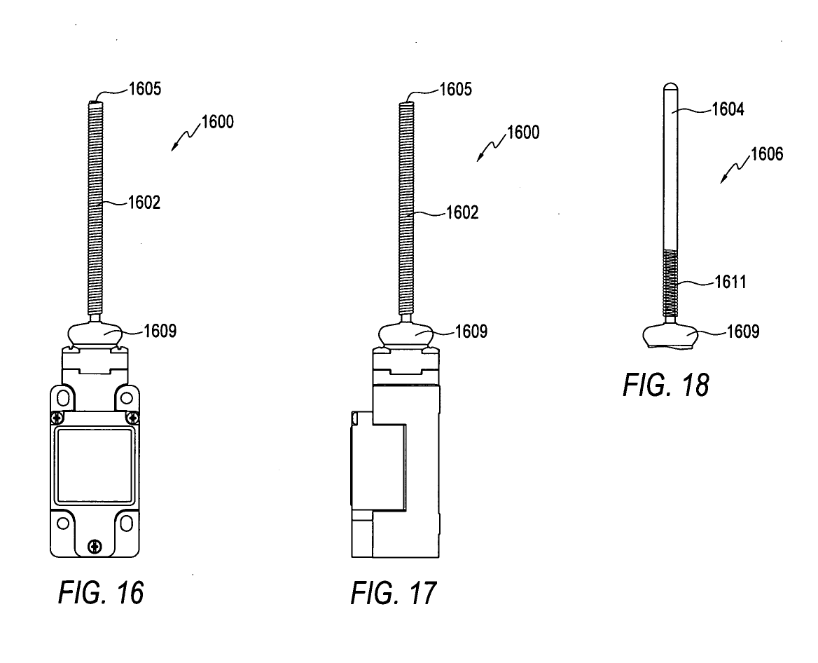

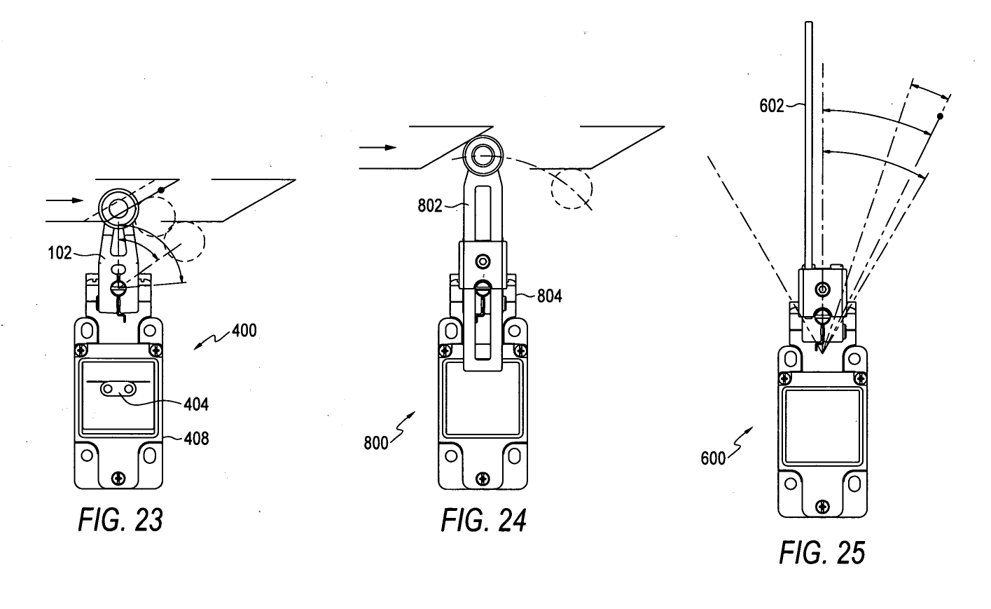

FIGS. 16-17 illustrate respective front and side views of a safety switch apparatus 1600 having a wobble head 1609 and cat whisker head coil actuator 1602 in accordance with an alternative embodiment. The safety switch apparatus 1600 is similar to the safety switch devices 100, 400, etc., that were described earlier herein, but includes the actuator 1602, which includes a plastic tip 1605. FIGS. 18-22 illustrate various types of actuators 1606, 1607, 1608, 1610, and 1612, which can be adapted for use in accordance with preferred or alternative embodiments. Note that each of the actuators 1606, 1607, 1608, 1610, and 1612 respectively depicted in FIGS. 23-25 can include a wobble head 1609. The actuator 1606 depicted in FIG. 18 can include, for example a plastic portion 1604 and a coiled metallic portion 1611. The actuator 1612 depicted in FIG. 22 can include a cable portion 1612 and the coiled metallic portion 1611.

FIGS. 23-25 illustrate angular actuation for a safety switch apparatus, which can be implemented in accordance with an alternative embodiment. In FIG. 23, safety switch apparatus 400 is shown, which was discussed earlier with respect to FIGS. 4-5. In FIG. 24, safety switch apparatus 800 is shown, which was discussed earlier with respect, to FIGS. 8-9. Similarly, in FIG. 25, safety switch apparatus 600 is depicted, which was discussed earlier with respect to FIGS. 6-7. Cam actuation is depicted per FIGS. 23-24, while angular actuation is shown with respect to all three FIGS. 23-25.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. A safety switch apparatus, comprising:
at least one switching element in association with an operating head;
a housing and a cover for maintaining said at least one switching element therein; and
a switch cavity is formed between said housing and said cover to maintain said at least one switching element in said switch cavity between said housing and cover, said housing and cover providing a plurality of cover-housing threads in association with a plunger extending between said switch cavity and said operating head, thereby providing a weather sealed explosion proof barrier for protecting said at least one switching element and said safety switch apparatus in hazardous location applications.

2. The apparatus of claim 1 wherein said operating head is field adjustable at 90 degree increments.

3. The apparatus of claim 1 wherein said operating head is equipped with a plurality of side rotary actuators adjustable for a clockwise operation and a counter-clockwise operation.

4. The apparatus of claim 1 further comprising an O-Ring seal located between said housing and said cover.

5. The apparatus of claim 1 further comprising a flame path provided by said plurality of cover-housing threads and said plunger extending between said switch cavity and said operating head.

6. The apparatus of claim 1 wherein said cover comprises a circular-shaped cover that is removable to expose said at least one switching element for wiring and replacement thereof.

7. The apparatus of claim 1 further comprising a plurality of wrenching lugs that extend from a front of said cover to permit a removal or a tightening of said cover.

8. The apparatus of claim 1 further comprising an external grounding mechanism that provides an earth ground for said housing.

9. The apparatus of claim 1 further comprising an internal grounding mechanism that provides an earth ground for said housing.

10. The apparatus of claim 1 wherein said at least one switching element comprises a positive-opening switch in association with a fixed side rotary lever, a top-pin plunger and a top roller plunger and top roller lever.

11. A safety switch apparatus, comprising:
at least one switching element in association with an operating head that is adjustable at 90 degree increments, and wherein said operating head is equipped with a plurality of side rotary actuators adjustable for a clockwise operation and a counter-clockwise operation;
a housing and a cover for maintaining said at least one switching element therein; and
a switch cavity is formed between said housing and said cover to maintain said at least one switching element in said switch cavity between said housing and cover, said housing and cover providing a plurality of cover-housing threads in association with a plunger extending between said switch cavity and said operating head, thereby providing a weather sealed explosion proof barrier for protecting said at least one switching element and said safety switch apparatus in hazardous location applications.

12. The apparatus of claim 11 further comprising an O-Ring seal located between said housing and said cover.

13. The apparatus of claim 11 further comprising a flame path provided by said plurality of cover-housing threads and said plunger extending between said switch cavity and said operating head.

14. The apparatus of claim 11 wherein said cover comprises a circular-shaped cover that is removable to expose said at least one switching element for wiring and replacement thereof.

15. The apparatus of claim 11 further comprising a plurality of wrenching lugs that extend from a front of said cover to permit a removal or a tightening of said cover.

16. The apparatus of claim 11 further comprising an external grounding mechanism that provides an earth ground for said housing.

17. The apparatus of claim 11 further comprising an internal grounding mechanism that provides an earth ground for said housing.

18. The apparatus of claim 11 wherein said at least one switching element comprises a positive-opening switch in association with a fixed side rotary lever, a top-pin plunger and a top roller plunger and top roller lever.

19. A safety switch apparatus, comprising:
at least one switching element in association with an operating head;
a housing and a cover for maintaining said at least one switching element therein;
an O-Ring seal located between said housing and said cover; and
a switch cavity is formed between said housing and said cover to maintain said at least one switching element in said switch cavity between said housing and cover, said housing and cover providing a plurality of cover-housing threads in association with a plunger extending between said switch cavity and said operating head, thereby providing a weather sealed explosion proof barrier for protecting said at least one switching element and said safety switch apparatus in hazardous location applications.

20. The apparatus of claim 19 wherein said operating head is field adjustable at 90 degree increments and wherein said operating head is equipped with a plurality of side rotary actuators adjustable for a clockwise operation and a counter-clockwise operation.
